(19) United States
(12) Patent Application Publication
(10) Pub. No.: US 2024/0391780 A1
(43) Pub. Date: Nov. 28, 2024

(54) METHOD FOR PRODUCING GRAPHITE PARTICLES

(71) Applicants: SEC CARBON, LIMITED, Hyogo (JP); I'MSEP CO., LTD., Kyoto (JP)

(72) Inventors: Koji KURODA, Kyoto (JP); Hiroaki AMAHASHI, Kyoto (JP); Wataru NISHIUMI, Kyoto (JP); Satoshi YANO, Kyoto (JP); Shota KAWAI, Kyoto (JP); Yasuhiko ITO, Kyoto (JP); Yoshikazu HYODO, Kyoto (JP); Akira KOYAMA, Kyoto (JP)

(73) Assignees: SEC CARBON, LIMITED, Hyogo (JP); I'MSEP CO., LTD., Kyoto (JP)

(21) Appl. No.: 18/699,005

(22) PCT Filed: Oct. 7, 2022
(86) PCT No.: PCT/JP2022/037739

§ 371 Date: Apr. 5, 2024

(30) Foreign Application Priority Data
Oct. 8, 2021 (JP) 2021-166279

(51) Int. Cl. C01B 32/205; C25B 1/135; C25B 9/09

(52) U.S. Cl. CPC C01B 32/205; C25B 1/135; C25B 9/09; C01P 2002/72; C01P 2004/03; C01P 2004/32; C01P 2004/51; C01P 2004/62; C01P 2006/12

(57) ABSTRACT

Provided is a method for manufacturing graphite particles using carbon dioxide as a raw material and which enables the graphite particles to be used as an electrode material.

The method includes: (a) preparing an electrolytic bath which includes molten salt containing carbonate ions; (b) locating a cathode in a vicinity of a surface of the electrolytic bath outside the electrolytic bath; (c) locating an anode in the electrolytic bath; (d) reducing the carbonate ions by generating electric discharge between the cathode and the surface of the electrolytic bath and performing energization by applying a voltage for generating carbon particles between the anode and the cathode; (e) collecting the carbon particles together with the molten salt and removing cooled and solidified salt by water washing; and (f) graphitizing the carbon particles being obtained in (e) by heat treatment.

### TECHNICAL FIELD

The present invention relates generally to a method for manufacturing graphite particles and, in particular, to a method for manufacturing graphite particles suitable for use as an electrode material.

### BACKGROUND ART

In the declaration of “Carbon Neutrality by 2050” announced by the Japanese government in 2020, realization of a decarbonized society by 2050 and net zero emissions of greenhouse effect gas are their goals. It is difficult to achieve these goals only by reduction of carbon dioxide, which forces suppression in economic activity, and technology which promotes the economic activity by recycling of the carbon dioxide and effective utilization thereof is required.

As a method for recycling the carbon dioxide, a method in which the carbon dioxide is converted into a carbonate to be utilized in cement and the like and a method in which the carbon dioxide is utilized as a raw material of polycarbonate as well as also technology which immobilizes carbon from the carbon dioxide have been attracting attention. The immobilized carbon is utilized as a raw material of graphite particles and the like.

As to the immobilization of the carbon dioxide, for example, in Japanese Patent Application Laid-Open Publication No. 2010-53425 (Patent Literature 1), an immobilization method of the carbon in the carbon dioxide by an electrochemical process using molten salt is described. In this method, a cathode and an anode are arranged in an electrolytic bath made of molten salt containing carbonate ions, the carbon dioxide is injected into the electrolytic bath and also a voltage by which the carbonate ions are reduced is applied between the cathode and the anode to pass electric current therebetween, and the carbon dioxide is decomposed and is immobilized on a surface of the cathode as the carbon.

On the other hand, as to manufacturing of the graphite particles, described in Japanese Patent Application Laid-Open Publication No. 2014-103095 (Patent Literature 2) is a method in which carbon powder as a raw material and a carbon precursor binder are melt-mixed; thereafter, a pressurized compact is prepared; the pressurized compact is changed into a graphitized compact by heat treatment; thereafter, the graphitized compact is pulverized; and graphite powder is thereby manufactured from the carbon powder.

### CITATION LIST

### Patent Literature

Patent Literature 1: Japanese Patent Application Laid-Open Publication No. 2010-53425
Patent Literature 2: Japanese Patent Application Laid-Open Publication No. 2014-103095

### SUMMARY OF THE INVENTION

### Technical Problem

However, in the immobilization method of the carbon dioxide described in Patent Literature 1, a method in which functionality is imparted to the carbon immobilized on the surface of the cathode is not described, and for example, the immobilization method is not a method for manufacturing a carbon material which can be utilized as an electrode material of a battery.

In addition, in the method for manufacturing graphite particles described in Patent Literature 2, the generated graphite powder receives influence of components of the carbon precursor binder.

Therefore, an object of the present invention is to provide a method for manufacturing graphite particles, which allows carbon dioxide to be used as a raw material and which enables the graphite particles to be used as an electrode material.

### Solution to Problem

The present inventors have devoted themselves to earnest research. As a result, the present inventors have found out that by locating a cathode in the vicinity of a surface of an electrolytic bath which includes molten salt containing carbonate ions, locating an anode in the electrolytic bath, and generating electric discharge between the cathode and the anode and reducing the carbonate ions, carbon particles can be generated in the molten salt and by subjecting the carbon particles to heat treatment, graphite particles which can be used as an electrode material can be obtained. Since the carbonate ions in the molten salt can be generated by injecting the carbon dioxide into the molten salt, the graphite particles can be manufactured with the carbon dioxide as a raw material. In addition, since upon subjecting the carbon particles obtained by this method to the heat treatment, it is not required to melt and mix a binder, the obtained graphite particles do not receive any influence of the binder.

A method for manufacturing graphite particles according to the present invention obtained on the basis of the above-described findings is constituted as follows.

The method for manufacturing graphite particles according to the present invention includes: (a) a step of preparing an electrolytic bath which includes molten salt containing carbonate ions; (b) a step of locating a cathode in a vicinity of a surface of the electrolytic bath outside the electrolytic bath; (c) a step of locating an anode in the electrolytic bath; (d) a step of reducing the carbonate ions by generating electric discharge between the cathode and the surface of the electrolytic bath and performing energization by applying a voltage for generating carbon particles between the anode and the cathode; (e) a step of collecting the carbon particles together with the molten salt and removing cooled and solidified salt by water washing; and (f) a step of graphitizing the carbon particles being obtained in (e) the step by heat treatment.

Thus, the carbon dioxide can be used as a raw material and the method for manufacturing graphite particles which can be used as an electrode material can be provided.

### BRIEF DESCRIPTION OF THE DRAWINGS

FIG. 1 is a diagram schematically showing a principle of a method for manufacturing carbon particles with carbon dioxide as a raw material.

FIG. 2 is a photograph showing an example of muddy carbon.

FIG. 3 is a photograph showing an example of aggregated carbon.

FIG. 4 is a diagram schematically showing an interplanar spacing d (002) and crystallite size Lc (002) and La (110) of a crystallite.

FIG. 5 shows graphs showing particle size distribution (A) of carbon particles in muddy carbon in Example 2A and particle size distribution (B) of carbon particles in aggregated carbon in Example 2B.

FIG. 6 shows SEM photographs of the carbon particles in Example 2A, (A) photographed with 5 kV×1000 and (B) photographed with 5 kV×10000.

FIG. 7 shows SEM photographs of the carbon particles in Example 2B, (A) photographed with 5 kV×1000 and (B) photographed with 5 kV×10000, and (C) and (D) are partially enlarged views of FIG. 7 (B).

FIG. 8 shows graphs showing X-ray diffraction profiles of (A) before heat treatment and (B) after heat treatment in Example 6A.

FIG. 9 shows graphs showing X-ray diffraction profiles of (A) before heat treatment and (B) after heat treatment in Example 7A.

FIG. 10 shows a graph showing an interplanar spacing d (002) of each of carbon particles and graphite particles in each of Examples 1A to 7A.

FIG. 11 shows graphs showing (A) Lc (002) and (B) La (110) of each of the carbon particles and the graphite particles in each of Examples 1A to 7A.

FIG. 12 shows SEM images of (A) carbon particles (before heat treatment) and (B) graphite particles (after heat treatment) in Example 4A.

FIG. 13 shows SEM images of (A) carbon particles (before heat treatment) and graphite particles (after heat treatment) in Example 6A and (B) carbon particles (before heat treatment) and graphite particles (after heat treatment) in Example 7A.

FIG. 14 shows SEM images used to visually measure a primary particle diameter in Example 4A.

FIG. 15 shows a graph showing changes in specific surface areas in Examples 4A and 4B due to heat treatment temperatures.

FIG. 16 shows graphs showing (A) a cyclic voltammogram of molten salt (a broken line) which does not contain oxide ions and of molten salt (a solid line) which contains the oxide ions and into which carbon dioxide is injected and (B) a cyclic voltammogram of molten salt which contains approximately 2.0 mol % of K₂CO₃.

FIG. 17 shows a graph showing particle size distribution of carbon particles in Example 8.

FIG. 18 shows a SEM photograph of carbon particles in Example 8 and an acquisition condition is 5 kV×10000.

FIG. 19 shows graphs showing (A) an X-ray diffraction profile before heat treatment and (B) an X-ray diffraction profile after heat treatment in Example 8.

FIG. 20 shows a SEM photograph of graphite particles in Example 8 and an acquisition condition is 5 kV×10000.

### DESCRIPTION OF EMBODIMENT

Hereinafter, an embodiment of the present invention will be described with reference to the accompanying drawings. Note that in the present description, unless otherwise specified, a “primary particle diameter” means an arithmetic mean particle diameter obtained by visual measurement using an electron microscope (SEM), a “secondary particle diameter (d50)” means that an integrated value in number base particle diameter distribution is a value of 50%, and a “specific surface area” is a BET specific surface area calculated from a nitrogen-adsorption amount at 77 K.

As to graphite particles manufactured by employing a manufacturing method according to the present invention, an interplanar spacing d002 based on a diffraction peak corresponding to a lattice plane (002) measured by employing a powder X-ray diffraction method is 0.3355 nm or more and 0.3370 nm or less, a primary particle diameter is 50 nm or more and 500 nm or less, a secondary particle diameter (d50) is 0.15 μm or more and 1.6 μm or less, and a specific surface area (BET) is 10 m²/g or more and 400 m²/g or less.

The graphite particles manufactured by employing the manufacturing method according to the present invention are, as described later, manufactured by manufacturing carbon particles with carbon dioxide as a raw material and subjecting the obtained carbon particles to heat treatment. Hereinafter, first, a method in which the carbon particles are manufactured with the carbon dioxide as the raw material will be described.

<A Principle of a Method for Manufacturing Carbon Particles with Carbon Dioxide as a Raw Material>

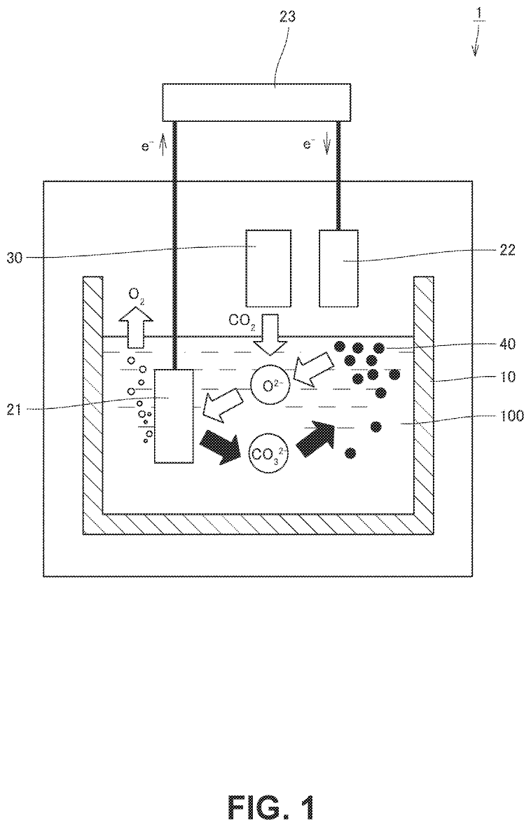

As shown in FIG. 1, a manufacturing apparatus 1 of carbon particles 40, schematically illustrated, includes a container 10 for housing an electrolytic bath 100, an anode 21, a cathode 22, a power supply part 23 to which the anode 21 and the cathode 22 are connected, and a carbon dioxide supply part 30. The electrolytic bath 100 contains molten salt and metallic oxide as an oxide ion (O²⁻) source. The metallic oxide supplies oxide ions (O²⁻) in the electrolytic bath 100. Note that the oxide ions may be supplied into the electrolytic bath 100 by employing other method.

When the carbon dioxide is externally supplied to the molten salt in which the oxide ions (O²⁻) are contained, carbonate ions (CO₃²⁻) are generated according to a formula (1) and the carbon dioxide is absorbed into the molten salt.

In molten salt: CO₂ (externally supplied)+O²⁻→CO₃²⁻ (1)

When this CO₃²⁻ is reduced by discharge electrolysis at the cathode, minute carbon particles 40 are generated in the electrolytic bath according to a formula (2).

Cathode reaction: CO₃²⁻+4e⁻→C (minute particles)+3O²⁻ (2)

In a case where the anode is an oxygen-generating anode, a part of O²⁻ generated at the cathode is oxidized according to a formula (3), thereby generating oxygen gas.

Anode reaction: 2O²⁻→O₂+4e⁻ (3)

On the other hand, in a case where as the anode, a carbon electrode is used, carbon monoxide or carbon dioxide is generated as shown below.

Anode reaction: C+O²⁻→CO+2e⁻or C+2O²⁻→CO₂+4e⁻ (4)

Since O²⁻ which has not been oxidized at the anode and has remained is utilized for CO₂ absorption reaction in the formula (1), as the entire reaction, carbon minute particles and oxygen are obtained by electrolysis of the carbon dioxide as shown in the following formula.

CO₂ (externally supplied)→C (minute particles)+O₂ (5)

### <Molten Salt>

As the molten salt, an alkali metal halide, an alkali earth metal halide, an alkali metal carbonate, and an alkali earth metal carbonate can be used.

As the alkali metal halide, a compound of LiF, NaF, KF, RbF, CsF, LiCl, NaCl, KCl, RbCl, CsCl, LiBr, NaBr, KBr, RbBr, CsBr, LiI, NaI, KI, RbI, CsI, or the like can be used.

As the alkali earth metal halide, a compound of MgF₂, CaF₂, SrF₂, BaF₂, MgCl₂, CaCl₂, SrCl₂, BaCl₂, MgBr₂, CaBr₂, SrBr₂, BaBr₂, MgI₂, CaI₂, SrI₂, BaI₂ or the like can be used.

As the alkali metal carbonate, a carbonate of Li₂CO₃, Na₂CO₃, K₂CO₃, or the like can be used.

As the alkali earth metal carbonate, a carbonate of MgCO₃, CaCO₃, BaCO₃, or the like can be used.

### <Oxide Ion (O²⁻) Source>

The oxide ion (O²⁻) source is previously supplied in the electrolytic bath. As the oxide ion (O²⁻) source, an alkali metal oxide and an alkali earth metal oxide can be used. As the alkali metal oxide, an oxide of Li₂O, Na₂O, K₂O, or the like can be used. As the alkali earth metal oxide, an oxide of MgO, CaO, BaO, or the like can be used.

### <Treatment Temperature>

A treatment temperature (a bath temperature of an electrolytic cell) is not particularly limited. However, because in a high temperature range exceeding 900° C., thermal decomposition of the carbonate itself becomes noticeable, a material of the electrolytic cell which can be used is limited, and handling is difficult, a treatment temperature of 250° C. or more and 800° C. or less is preferable.

### <Cathode>

In the method for manufacturing graphite particles according to the present invention, as shown in FIG. 1, the cathode is not immersed in the electrolytic bath and is located in the vicinity of a surface of the electrolytic bath on the outside of the electrolytic bath. In other words, the carbonate ions are not reduced on the surface of the cathode immersed in the electrolytic bath but the carbonate ions can be reduced in the vicinity of the surface of the electrolytic bath by discharged electrons. Thus, because the carbon particles are formed from an atomic level, extremely minute carbon particles can be formed.

In addition, the electrode is not immersed in the electrolytic bath, whereby impurities derived from a cathode base material are hardly mixed into the electrolytic bath. Furthermore, because all formed carbon particles are present in the electrolytic bath, collection of the carbon particles is facilitated.

As a material of the cathode, kinds of metal such as iron, nickel, molybdenum, tantalum, and tungsten; alloys thereof; a carbon material such as glass-like carbon and a conductive diamond; conductive ceramics; semiconductive ceramics, or the like can be used. In addition, a cathode obtained by forming each of these on a different kind of a material can also be used as the cathode.

### <Anode>

As a material of the anode, an electrode material which can oxidize O²⁻ generated by the reduction reaction of the carbonate ions (CO₃²⁻) shown in the formula (2) is used. As one example, carbon or an inert anode is mainly used.

As the inert anode, an insoluble electrode whose base body surface formed of metal such as Ti is coated with RuO₂, IrO₂, RhO₂, or Ta₂O₅; a conductive ceramics electrode formed of nickel ferrite represented by Ni_{X}Fe_{3-X}O₄ (X=0.1 to 2.0) or of a nickel cobalt oxide represented by a composition formula: Ni_{X}Co_{1-X}O (X=0.1 to 0.5 or a formula: Ni_{X}Co_{3-X}O₄ (X=0.3 to 1.5); a conductive diamond electrode; or the like can be used.

### <Collection of Carbon Particles>

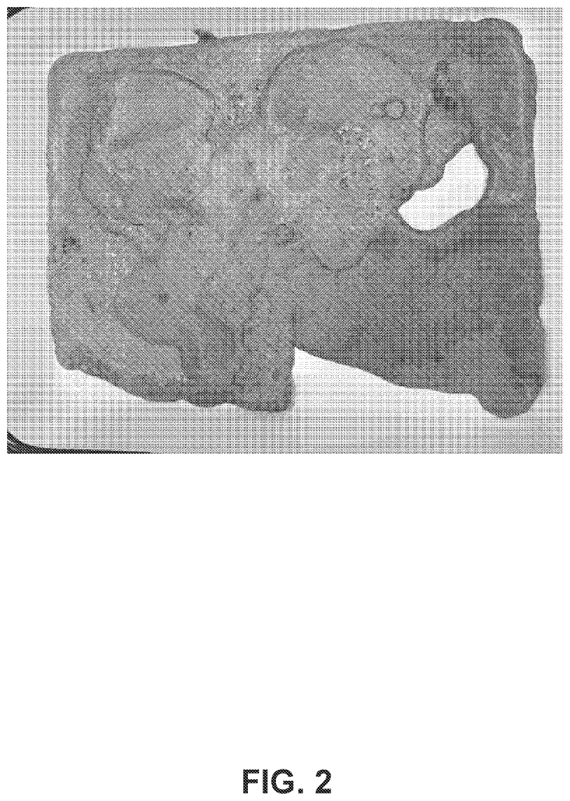

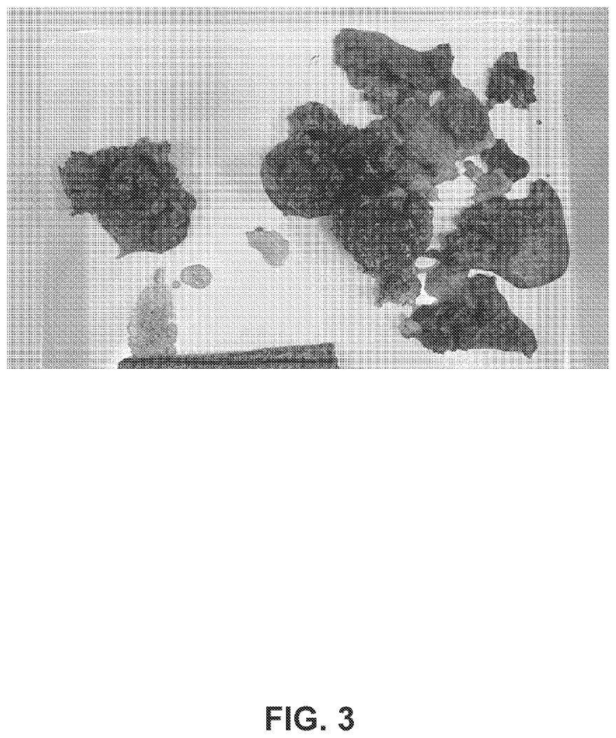

The carbon particles formed in the above-described electrolytic bath are present in the following two states in the molten salt. One is a state in which the carbon particles are dispersed in the bath of the molten salt and become muddy (hereinafter, referred to as “muddy carbon”) (FIG. 2). Another one is a state in which aggregations of the carbon particles grow until each of the aggregations forms a clump having a size of approximately several cm and the molten salt is wound in the clump (hereinafter, referred to as “aggregated carbon”) (FIG. 3).

In a step of collecting the carbon particles, an electrolytic bath containing the muddy carbon and an electrolytic bath containing the aggregated carbon are separated, are carried out of the electrolytic cell, and are made into solidified salt at a room temperature. The solidified salt of each of the electrolytic baths is individually dissolved in water or warm water whose temperature is 50° C. or less and while ultrasonic is applied thereto, carbon particles are suspended in an aqueous solution. The obtained suspension is filtered by a membrane filter and carbon particles deposited on the filter are dried, thereby obtaining a carbon pulverulent body.

### <Shapes of Carbon Particles (Before Heat Treatment)>

As shapes of the carbon particles finally obtained in the above-described collecting step, in addition to a spherical shape, there are a sheet shape, a ribbon shape, and a cube shape. It is considered that the carbon particles having the various shapes as mentioned above can be obtained because the reduction of the carbonate ions is utilized to generate the carbon particles. Note that the carbon particles may be manufactured by employing other method and the carbon particles may be constituted of particles each having a single shape.

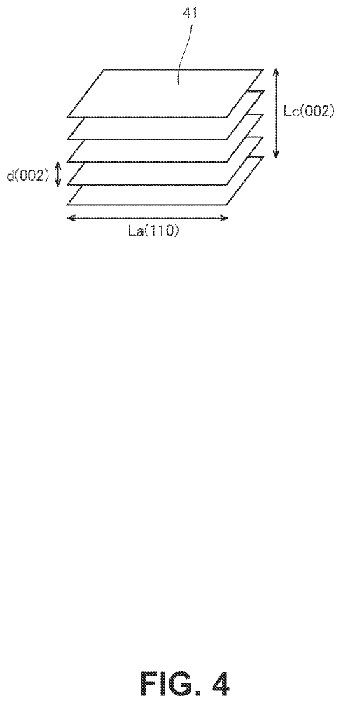

Since a temperature of the electrolytic bath immediately beneath the electric discharge is approximately 3000° C., formation of the carbon particles and the heat treatment concurrently proceed, and as shown in FIG. 4, crystallites 41 of the carbon particles, obtained from the carbon particles generated in the electrolytic bath, have a structure having an interplanar spacing d (002) which is close to that of graphite. It is preferable that the interplanar spacing d (002) of the carbon particles is 0.3360 nm or more and 0.3373 nm or less. In addition, it is preferable that a secondary particle diameter (d50) of the carbon particles is 150 nm or more and 200 nm or less. In addition, it is preferable that a BET specific surface area of the carbon particles is 200 m²/g or more and 600 m²/g or less. As one embodiment, by subjecting the above-described carbon particles to heat treatment as described below, a graphite pulverulent body which is suitable for use as an electrode material can be obtained.

### <A Method for Manufacturing Graphite Particles>

The carbon particles obtained as described above are subjected to the heat treatment, thereby graphitizing the carbon particles. It is preferable that a heat treatment temperature is 2800° C. or more. Since it is not required to add a carbon precursor binder to the carbon particles, any influence of binder components is not received.

<Characteristics of Generated Graphite Particles (after Heat Treatment)>

An interplanar spacing d 002 of the graphite particles manufactured by the manufacturing method according to the present invention based on a diffraction peak corresponding to a lattice plane (002), which is measured by a powder X-ray diffraction method, is 0.3355 nm or more and 0.3370 nm or less. A primary particle diameter of the graphite particles is 50 nm or more and 500 nm or less, an integrated value in number base particle diameter distribution of the graphite particles which is a value (a mean particle diameter) of 50% is defined as a secondary particle diameter (d50), and the secondary particle diameter (d50) is 0.15 μm or more and 1.6 μm or less. A specific surface area (BET) of the graphite particles, which is calculated from a nitrogen-adsorption amount at 77 K is 10 m²/g or more and 400 m²/g or less and preferably, 50 m²/g or more and 70 m²/g or less.

The graphite pulverulent body which is aggregate of the graphite particles includes variously shaped graphite particles. Representative shapes of the carbon particles included in the carbon pulverulent body before the heat treatment are a sheet shape, a ribbon shape, and a cube shape. Also in the graphite particles obtained by subjecting the carbon particles including variously shaped carbon particles to the heat treatment, variously shaped graphite particles are included. It is preferable that the graphite particles include graphite particles each having a sheet shape, a ribbon shape, and a cube shape. The graphite particles may be constituted of graphite particles each having a single shape.

### Examples

With reference to Examples, the present invention will be further specifically described. Note that the present invention is not limited by these Examples at all.

As molten salt, 900 g to 3100 g of eutectic salt of LiCl and KCl (eutectic composition is 58.5:41.5 mol %) was melted under an argon atmosphere at atmospheric pressure and was retained at 450° C. As a carbonate ion source, an amount of K₂CO₃ whose salt concentration is 2 mol % was added into the molten salt, and by injecting argon gas thereto, an electrolytic bath was agitated, thereby conducting suspension and dispersion in the electrolytic bath. As an anode, a carbon plate was located in the electrolytic bath. In the vicinity of a surface of the electrolytic bath outside the electrolytic bath, as a cathode which was a discharge electrode, a tungsten rod was located. Discharge electrolysis was performed for the above-described electrolytic bath with an electrolytic current of 2 A to 4 A and a quantity of electricity of 107208 C to 450000 C (coulomb).

In Examples 1 to 7, weights of the molten salts, electrolytic currents, and quantities of electricity are different. In Example 1, a weight of the molten salt was 900 g, an electrolytic current was 3 A, and a quantity of electricity was 107208 C; in each of Examples 2 to 5, a weight of the molten salt was 1350 g, an electrolytic current was 2 A, and a quantity of electricity was 200000 C; and in each of Examples 6 to 7, a weight of the molten salt was 3100 g, an electrolytic current was 2 A, and a quantity of electricity was 450000 C.

After the electrolysis, in all of Examples, the muddy carbon and the aggregated carbon were formed in the electrolytic bath. The muddy carbon and the aggregated carbon were moved outside the electrolytic cell and were made into the solidified salt at a room temperature. The solidified salt containing the muddy carbon and the solidified salt containing the aggregated carbon were individually dissolved in warm water at a temperature of 50° C. or less or water, and carbon particles were suspended in the aqueous solutions while ultrasonic was applied thereto. Each of the obtained aqueous solutions was filtered by a membrane filter and carbon particles deposited on the filter were dried. Hereinafter, as to Examples 1 to 7, the muddy carbon is shown as Examples 1A to 7A and the aggregated carbon is shown as Examples 1B to 7B.

An interplanar spacing d (002) (nm), a crystallite size (Lc (002) (nm), La (110) nm), a mean secondary particle diameter (d50) (nm), and a specific surface area of the carbon particles collected in each of Examples 1A to 7A (muddy carbon) and each of Examples 1B to 7B (aggregated carbon) were measured. A result of the measurement in Examples 1A to 7A (muddy carbon) is shown in Table 1.

The interplanar spacing d (002) (nm), the crystallite size (Lc (002) (nm), and La (110) nm) of the carbon particles were measured by the XRD (X-ray diffractometry) Gakushin method.

The mean secondary particle diameter (d50) (nm) was measured by using a particle diameter distribution measurement apparatus: Nanotrac UPA, model: UPA-EX, manufactured by MicrotracBEL Corp.

The specific surface area was measured by the BET method in which a specific surface area was calculated from a nitrogen-adsorption amount at 77 K.

TABLE 1

| Carbon | | | | | | |
|---|---|---|---|---|---|---|
| particles | State in | d | Lc | La | | Specific |
| (before heat | molten | (002) | (002) | (110) | (d50) | surface area |
| treatment) | salt | [nm] | [nm] | [nm] | [nm] | [m²/g] |
| Example 1A | muddy | 0.3371 | 6.5 | 104.2 | 170 | — |
| Example 2A | muddy | 0.3365 | 34.6 | 38.1 | 150 | — |
| Example 3A | muddy | 0.3360 | 41.9 | 152.8 | 160 | — |
| Example 4A | muddy | 0.3363 | 11.3 | 233.7 | 180 | 465 |
| Example 5A | muddy | 0.3365 | 15 | 4.8 | 150 | — |
| Example 6A | muddy | 0.3373 | 32.8 | 174.6 | 160 | — |
| Example 7A | muddy | 0.3366 | 15.9 | 101.9 | 200 | — |

As shown in Table 1, the interplanar spacing (d (002)) of the carbon particles in each of Examples 1A to 7A (muddy carbon) was 0.3360 nm or more and 0.3373 nm or less, and particles having crystallinity which was equivalent to that of graphite were included.

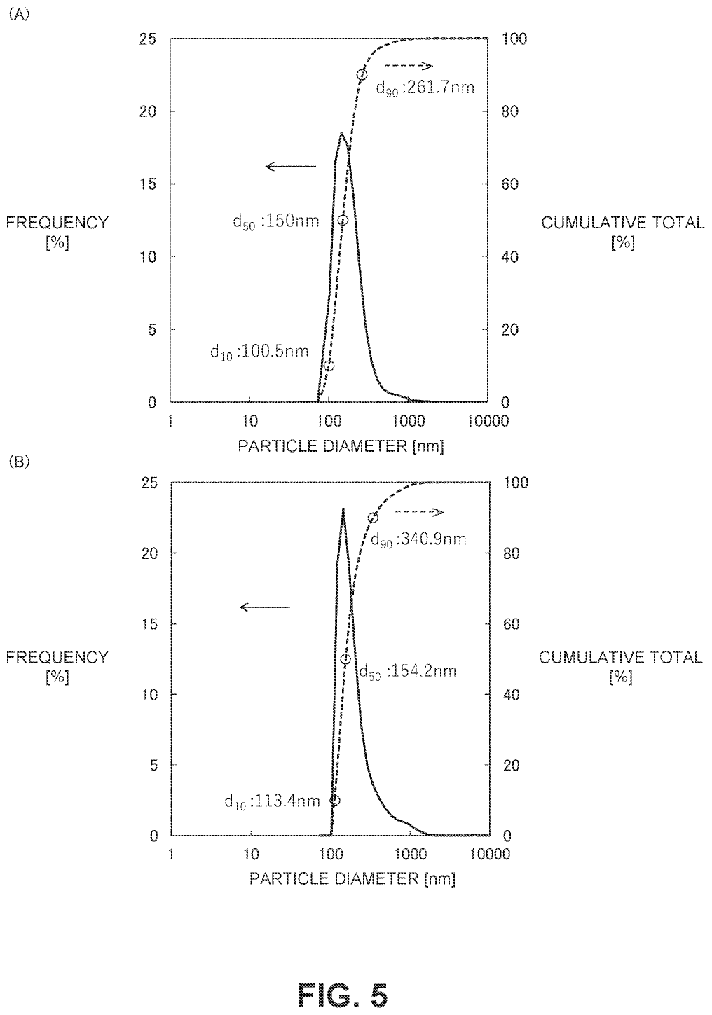

As shown in FIG. 5, a secondary particle diameter (d50) of carbon particles of each of the muddy carbon (Example 2A) and the aggregated carbon (Example 2B), which were obtained after cleaning and drying, was 150 nm or more and 200 nm or less.

A BET specific surface area of the carbon particles was 200 m²/g or more and 500 m²/g or less.

### <Impurities in Carbon Particles>

As impurities of the collected carbon particles in Example 4, contained a mounts of potassium and chlorine of molten salt components were measured. The impurities were measured by an EDX method. A result of the measurement is shown in Table 2.

TABLE 2

| | Example 4A | Example 4B |
|---|---|---|
| | (muddy carbon) | (aggregated carbon) |
| Element | Contained amount [at %] | Contained amount [at %] |
| C | 98.45 | 96.63 |
| Cl | 0.74 | 1.66 |
| K | 0.81 | 1.71 |

### <Shapes of Carbon Particles>

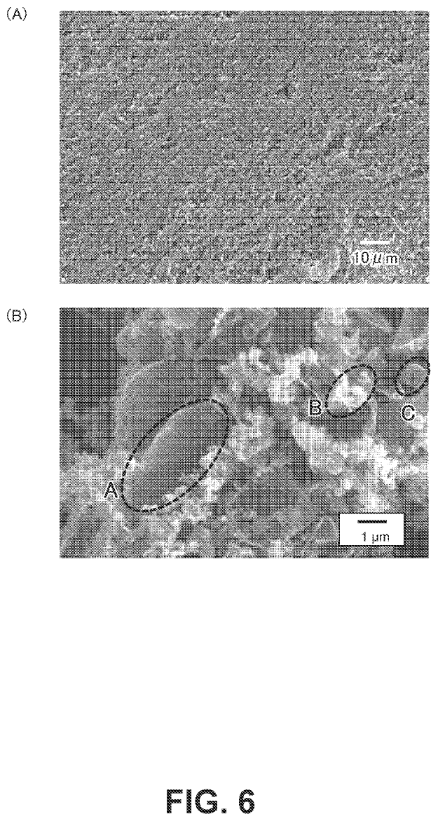

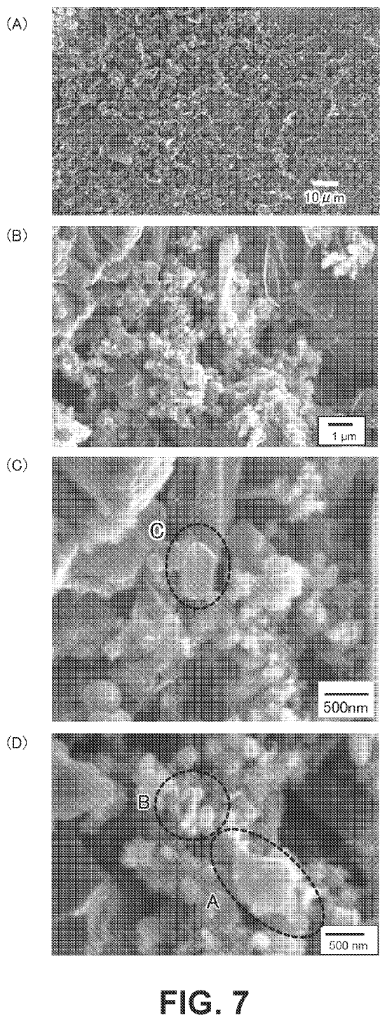

Carbon particles of each of Examples 2A and 2B were observed by a SEM (manufactured by JEOL Ltd., JSM-6010PLUS/LA). As shown in FIGS. 6 and 7, as to shapes of the carbon particles, particles each having a structure of not only a spherical shape but also a sheet shape, a ribbon shape, and a cube shape were also present, and particles having various shapes were included. In FIG. 6 (B) and FIGS. 7 (C) and (D), in portions each surrounded by an A line, carbon particles each having the sheet shape were observed, in portion each surrounded by a B line, carbon particles each having the ribbon shape were observed, and in portions each surrounded by a C line, carbon particles each having the cube shape were observed. As these results of the SEM observation, it was found that in the carbon particles of each of the muddy carbon (Example 2A) and the aggregated carbon (Example 2B), not only the spherical shape particles but also the sheet shape particles, the ribbon shape particles, and the cube shape particles were present in a mixed manner and particles having various shapes were included. As described above, it was made possible to manufacture a carbon pulverulent body including carbon particles which had the various shapes with the carbonate ions as a raw material.

### <Manufacturing of Graphite Particles>

Carbon particles in each of Examples 1 to 7 were subjected to heat treatment at 2800° C. for one hour, thereby obtaining graphite particles. An interplanar spacing d (002) (nm), a crystallite size (Lc (002) (nm) and La (110) (nm)), a mean secondary particle diameter (d50) (nm), and a specific surface area of the obtained graphite particles were measured in a manner similar to the manner in which the measurement for the carbon particles before the heat treatment was conducted. A result thereof is shown in Table 3.

TABLE 3

| Graphite particles | d (002) | Lc (002) | La (110) | (d50) | Specific surface |
|---|---|---|---|---|---|
| (after heat treatment) | [nm] | [nm] | [nm] | [nm] | area [m²/g] |
| Example 1A | 0.3361 | 19 | 78.5 | 1200 | — |
| Example 2A | 0.3363 | 30.5 | 115.8 | 1200 | — |
| Example 3A | 0.3361 | 28.5 | 84.3 | — | — |
| Example 4A | 0.3365 | 24.5 | 63.3 | 1600 | 58 |
| Example 5A | 0.3360 | 20 | 57 | — | — |
| Example 6A | 0.3361 | 17.6 | 49.5 | 170 | — |
| Example 7A | 0.3358 | 20.1 | 84.7 | 190 | — |

As shown in Table 3, the interplanar spacing d (002) based on a diffraction peak corresponding to the d (002) of the graphite particles in each of Examples 1 to 7 was 0.3355 nm or more and 0.3365 nm or less.

### <Evaluation of Crystallinity of Graphite Particles>

In general, the higher crystallinity of graphite is, the more excellent characteristics such as thermal conductivity, electrical conductivity, slidability, lubricity, and heat resistance are exhibited. However, since where it is often the case that definition of the graphite is ambiguous in documents, the crystallinity of the graphite particles generated by employing the above-mentioned method was evaluated.

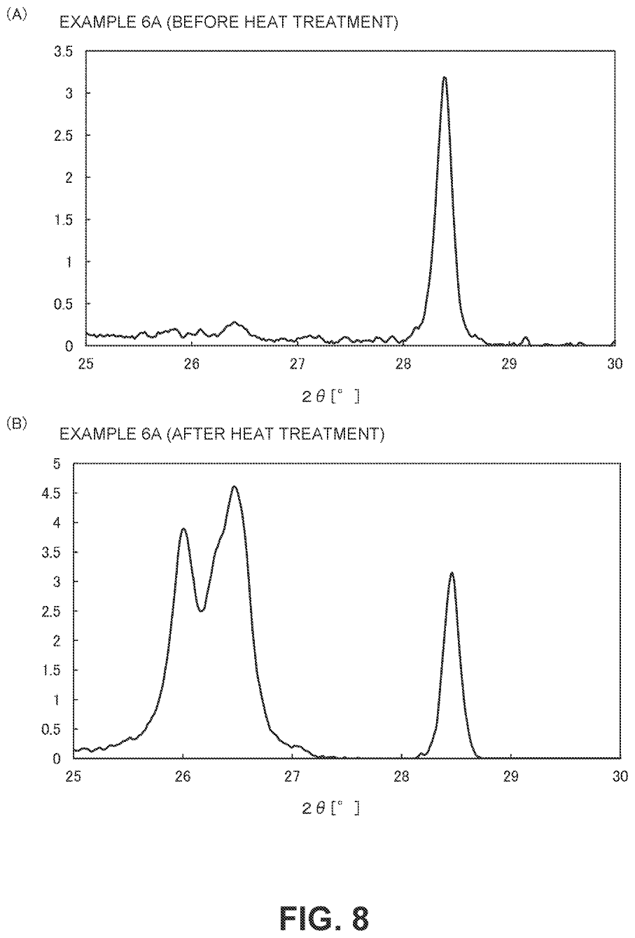

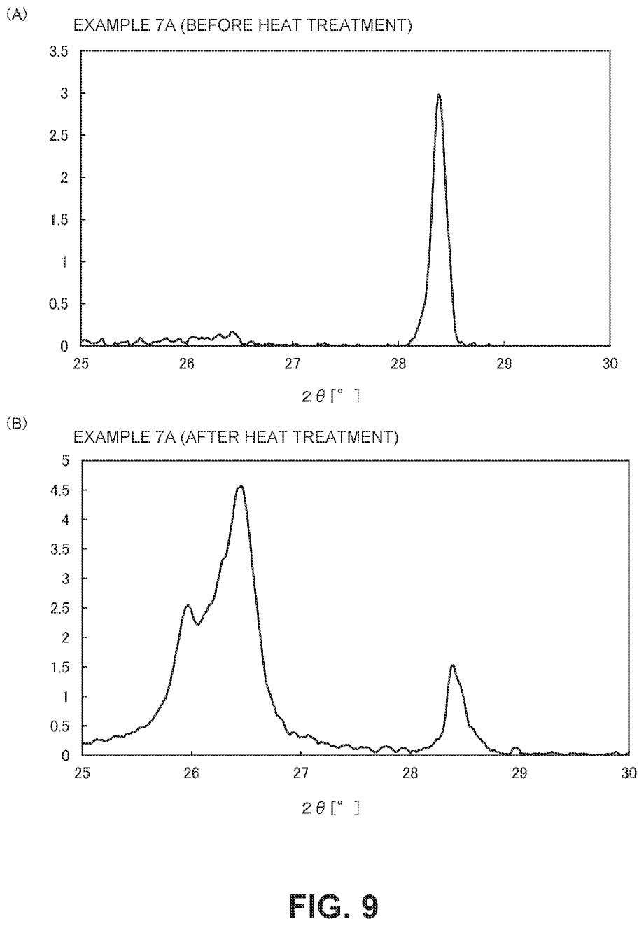

In general, as graphite peaks, a peak having low crystallinity, which is a turbostratic structure component (a T component), is exhibited at a diffraction angle (2θ) of 26° and a peak having high crystallinity, which is a graphitic structure component (a G component), is exhibited at a diffraction angle (2θ) of 26.5°. As shown in FIGS. 8 and 9, although as to the carbon particles before the heat treatment, which was a raw material of graphite particles, there was no peak in the vicinity of 26.5° and graphitic nature was not observed, after the heat treatment, a peak at a diffraction angle (2θ) of 26.5°, which was higher than a peak of a diffraction angle (2θ) of 26°, was exhibited, and it was made clear that a graphitic structure was present in the particles.

In order to quantify a degree of progress of graphitizing, a graphitization degree P1 was obtained by the following formula.

$$d ( 002 ) = 0.335 P 1 + 0.344 ( 1 - P 1 )$$

A result thereof is shown in Table 4. It is indicated by P1 that the more proximate to one P1 is, the more progressing the graphitizing is, and it turned out that in each of Examples, the graphitization degree of the graphite particles was high.

TABLE 4

| Example | d (002) [nm] | P1 |
|---|---|---|
| Example 1A | 0.3361 | 0.88 |
| Example 2A | 0.3363 | 0.86 |
| Example 3A | 0.3361 | 0.88 |
| Example 4A | 0.3365 | 0.83 |
| Example 5A | 0.3360 | 0.89 |
| Example 6A | 0.3361 | 0.88 |
| Example 7A | 0.3358 | 0.91 |

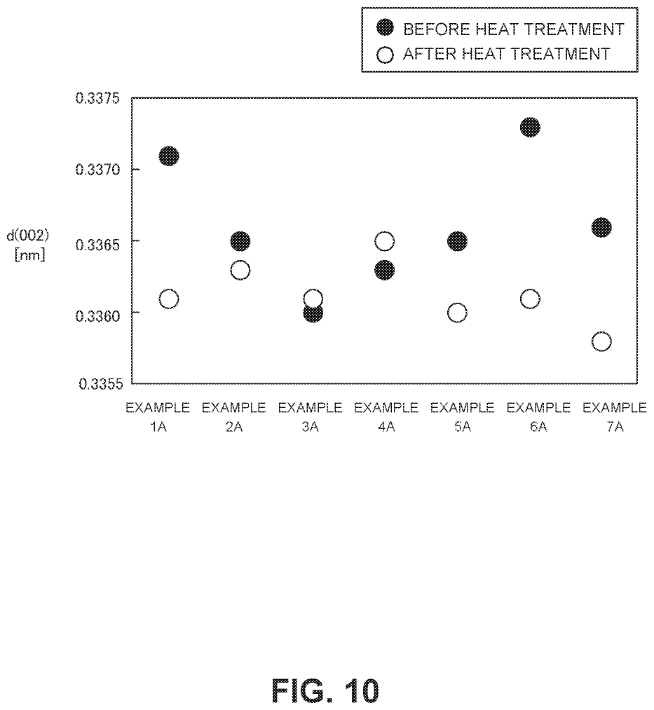

Next, an interplanar spacing d (002) of each of the carbon particles before the heat treatment and the graphite particles after the heat treatment was examined. A theoretical value of d (002) of the graphite is 0.3354 nm. Values of the interplanar spacing d (002) of the carbon particles after graphitizing in Examples 1 to 7 were in a range of 0.3355 nm or more and 0.3368 nm or less and were equivalent to values of synthetic graphite and natural graphite. As shown in FIG. 10, it is seen that by applying the heat treatment thereto, variation in the values of d (002) which was present among Examples is reduced.

### <Crystallite Size of Graphite Particles>

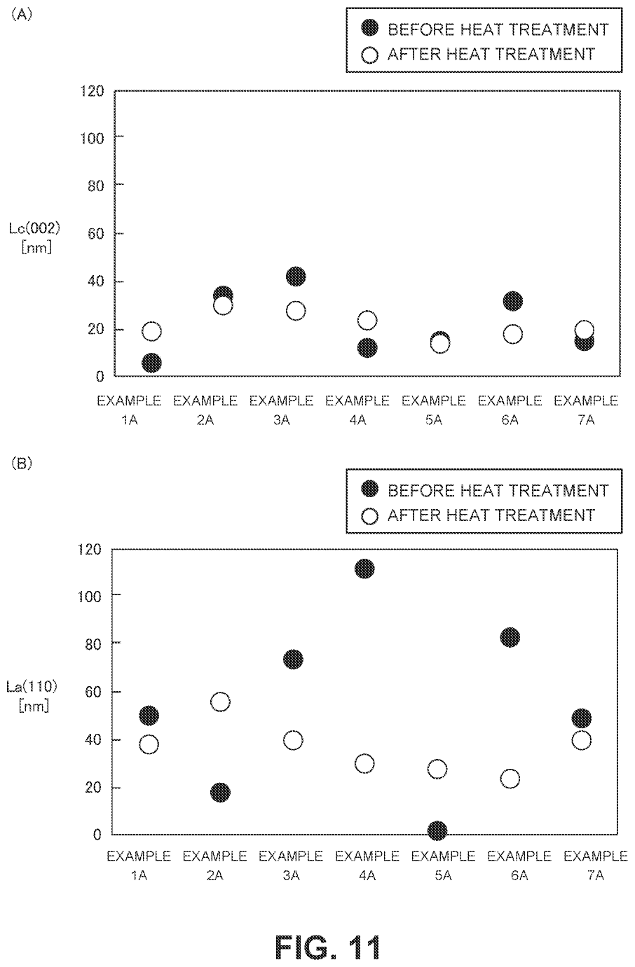

As shown in Table 3 and FIG. 11, Lc (002) of the graphite particles after graphitizing was in a range of 15 nm or more and 30 nm or less and La (110) thereof was in a range of 50 nm or more and 110 nm or less.

As general synthetic graphite, Lc (002) of synthetic graphite manufactured by SEC CARBON, Ltd. is 117 nm, La (110) thereof is 284.6 nm. Both of Lc (002) and La (110) of the graphite particles in each of Examples 1 to 7 are ⅓ or less of those of the general synthetic graphite.

Means and standard deviations of La and Lc before and after the heat treatment in Examples 1A to 7A (muddy carbon) are shown in Table 5.

TABLE 5

| | La (110) [nm] | | Lc (002) [nm] | |
|---|---|---|---|---|
| Examples 1A to 7A | | Standard | | Standard |
| (muddy carbon) | Mean | deviation | Mean | deviation |
| Carbon particles | 115.73 | 78.97 | 22.57 | 13.60 |
| (before heat treatment) | | | | |
| Graphite particles | 76.16 | 22.21 | 22.89 | 5.02 |
| (after heat treatment) | | | | |

As shown in Table 5, the standard deviations of La (110) and Lc (002) after the heat treatment were decreased from those before the heat treatment, and it is seen that variation in the crystallite sizes can be reduced.

### <Particle Diameter of Graphite Particles>

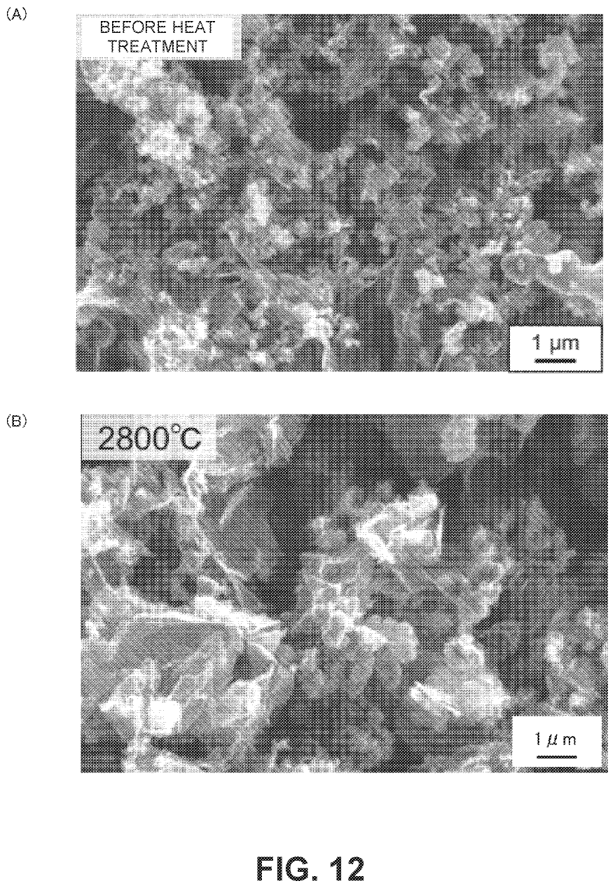

As shown in Table 3, the secondary particle diameter of the graphite particles is 0.15 μm or more and 1.6 μm or less. In Examples 1 to 5, a particle diameter of the graphite particles after the heat treatment at 2800° C. became drastically larger than a particle diameter of the carbon particles before the heat treatment. For example, in Example 4, while a carbon particle diameter of the carbon particles as the raw material was 180 nm (d50), a graphite particle diameter was 1600 nm (d50). As shown in FIG. 12, in the SEM observation, aggregation of the particles due to the heat treatment was confirmed.

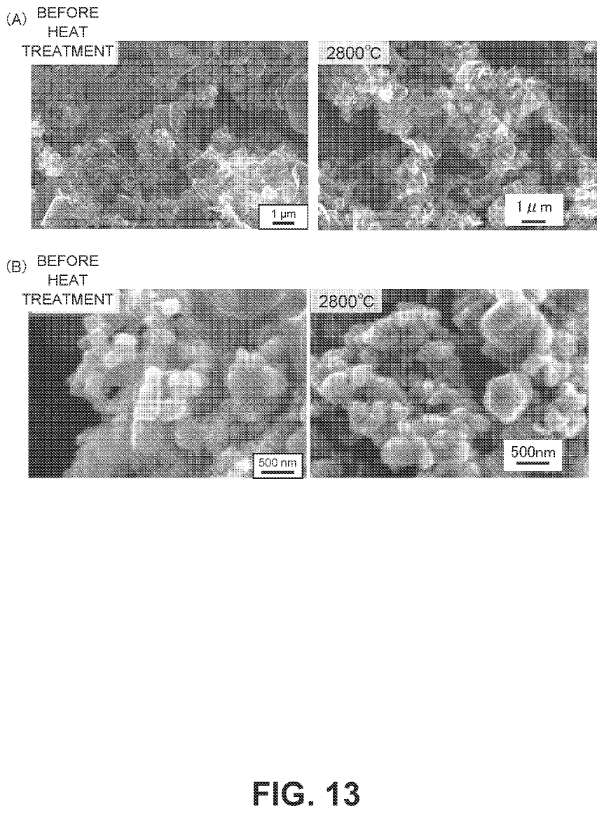

On the other hand, in Examples 6 and 7, a particle diameter after graphitizing was substantially the same as a particle diameter of the carbon particles as the raw material. As shown in FIG. 13, as a result of the SEM observation in Examples 6 and 7, it was confirmed that aggregation of the carbon particles due to the heat treatment did not occur.

The reason why further minute graphite particles were obtained without the occurrence of the aggregation due to the heat treatment in Examples 6 and 7 is because it is considered that increasing a generated amount of the carbon particles as the raw material caused concurrently the following two phenomena.
(1) Prolonging the electrolysis time increased chances of contacting of the particles in the electrolytic bath with the discharge plasma and a crystal structure of many carbon particles was thereby approximated to that of the graphite.
(2) By previously increasing an amount of the electrolytic bath in accordance with a quantity of electricity, in a period from an early stage of the electrolysis to a middle stage thereof, the number of carbon particles per unit volume of the electrolytic bath (a carbon particle density) became smaller than that obtained upon small-scale production, thereby decreasing chances of mutual collision and bonding of the carbon particles in the electrolytic bath.

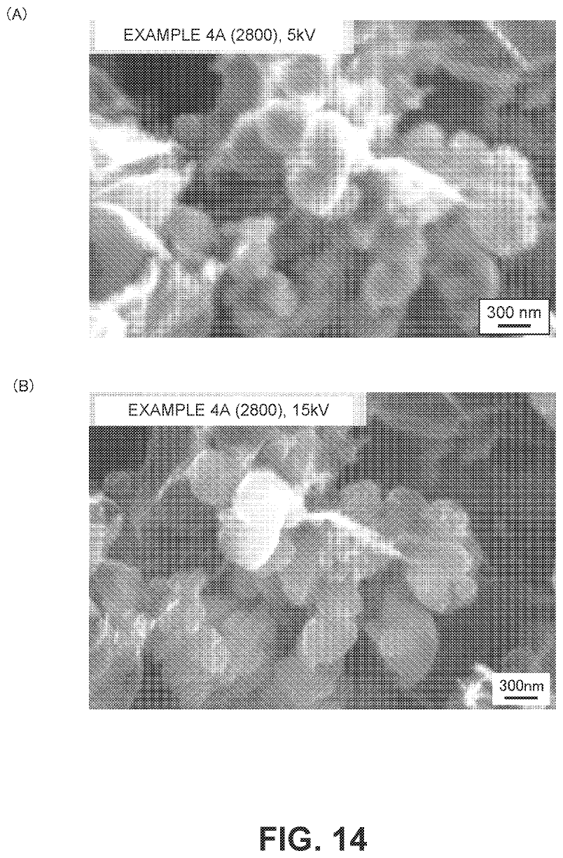

As a primary particle diameter of the graphite particles in Examples 1 to 7, as shown in FIG. 14, a particle diameter visually measured by the SEM (an electron microscope) was 50 nm or more and 500 nm or less.

### <Specific Surface Area>

A specific surface area (BET) of the graphite particles in Examples 1 to 7 obtained from the nitrogen-adsorption amount at 77 K was 50 m²/g or more and 60 m²/g or less.

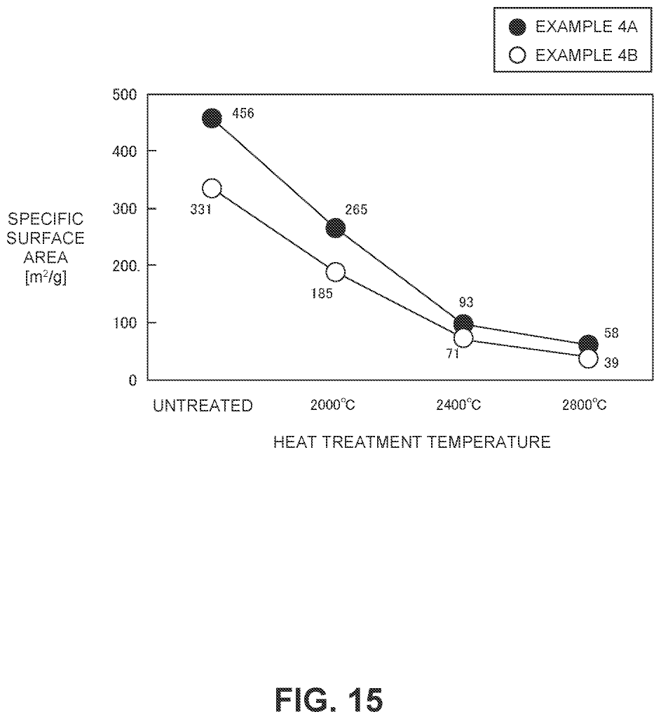

As shown in FIG. 15, while when a heat treatment temperature of the carbon particles in Examples 4A and 4B was changed, a specific surface area of the carbon particles as the raw material was 300 m²/g or more and 500 m²/g or less, after the heat treatment, there was a tendency that the higher the heat treatment temperature was, the more decreased the specific surface area was. As a reason for this, as described above, it is considered that by performing the heat treatment, aggregation of the carbon particles occurred and the particle diameter became large.

### <Shapes of Graphite Particles>

The graphite pulverulent body was observed by a SEM (manufactured by JEOL Ltd., JSM-6010PLUS/LA). As to shapes of the graphite particles, particles each having not only a structure of a spherical shape but also a sheet shape, a ribbon shape, and a cube shape were also present, and particles having various shapes were included. As these results of the SEM observation, it was found that not only the spherical shape particles but also the sheet shape particles, the ribbon shape particles, and the cube shape particles were present in a mixed manner and particles having various shapes were included. The reason why the graphite particles having the above-mentioned various shapes were formed is because in the stage of the carbon particles as the raw material, the shapes of the particles have already been diversified. As described above, it is considered that the carbonate ions generated in the molten salt with the carbonate ions in the molten salt as the raw material were subjected to the cathode discharge electrolysis, thereby obtaining the carbon particles having the various shapes, and various shapes of also the graphite particles obtained by subjecting the obtained carbon particles to the heat treatment were exhibited.

Furthermore, in TEM photographs of the graphite particles each having the ribbon shape, stacking of graphene sheets was confirmed, and it can be said that the graphite particles even having the various shapes have graphitic nature.

### <Impurities in Graphite Particles>

As impurities of the graphite particles in Example 4A, contained amounts of potassium and chlorine of molten salt components were measured. The impurities were measured by an EDX method. A result is shown in Table 6.

TABLE 6

| Example 4A | Contained amount [at %] | | | |
|---|---|---|---|---|
| Element | Before heat treatment | 2000° C. | 2400° C. | 2800° C. |
| C | 98.45 | 99.93 | 99.97 | 99.99 |
| Cl | 0.74 | 0.03 | 0.03 | 0.01 |
| K | 0.81 | 0.04 | 0.00 | 0.00 |

As shown in Table 6, it was confirmed that by increasing the heat treatment temperature, the impurities decreased and at 2800° C., the impurities substantially vanished. Accordingly, it is preferable that the treatment temperature of graphitizing is 2800° C. or more.

<Manufacturing of Graphite Particles with Carbon Dioxide Gas as a Raw Material>

### Example 8

Hereinafter, carbon particles generated from an electrolytic bath prepared by injecting carbon dioxide gas into the electrolytic bath which includes molten salt containing oxide ions and graphite particles manufactured by performing the heat treatment will be described.

Under an argon atmosphere at atmospheric pressure, 400 g of eutectic salt (eutectic composition was 58.5:41.5 mol %) of LiCl and KCl as the molten salt was melted and was retained at 450° C. Added into the molten salt was an amount of Li₂O as an oxide ion source, which made a concentration 1 mol %, and by injecting argon gas thereto, the electrolytic bath was agitated, thereby making suspension and dispersion in the electrolytic bath. Thereafter, argon gas containing 10 vol % of carbon dioxide was injected into the electrolytic bath at a flow rate of 100 mL/minute for 24 hours. In order to confirm that carbonate ions were generated, cyclic voltammetry was performed in such a way that a Ni wire was used as a cathode, a glass-like carbon rod was used as an anode, an Ag(I)/Ag electrode which included LiCl—KCl eutectic salt containing 1 mol % of AgCl and an Ag wire was used as a reference electrode, and a scan rate was 10 mV/s. As a comparison target, measurement was similarly made in such a way that molten salt which contained K₂CO₃ having approximately 2.0 mol % was used and a scan rate was 100 mV/s.

Thereafter, discharge electrolysis was performed for the above-mentioned molten salt into which the carbon dioxide was injected in such a way that an anode and a cathode which were similar to those used in Examples 1 to 7 were used, an electrolytic current was 2 A, and a quantity of electricity was 10000 C.

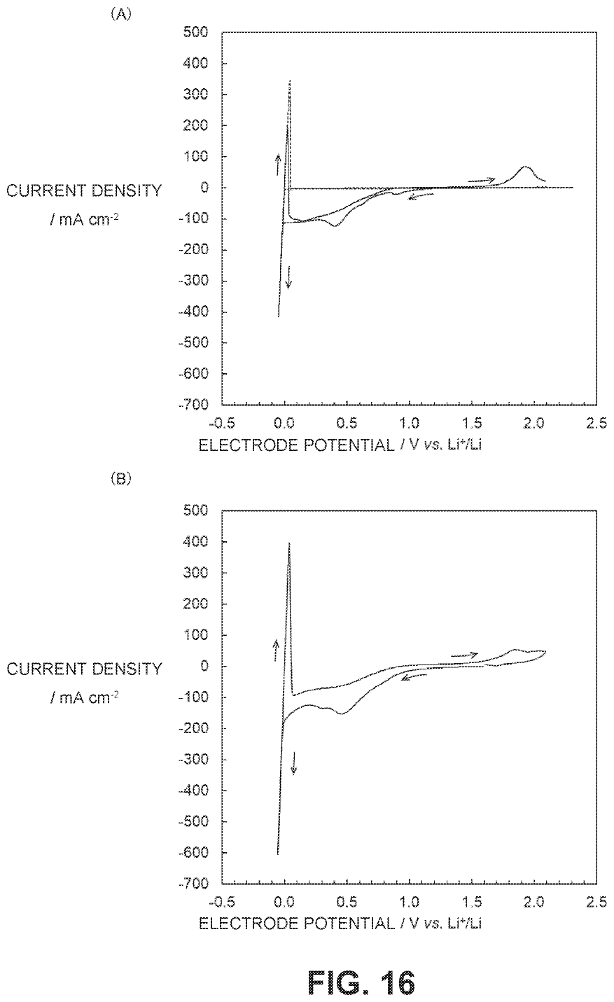

As shown in FIG. 16 (A), when only in the electrolytic bath into which the carbon dioxide was injected, an electrode potential was scanned in a negative direction, a reduction current started to flow from the vicinity of 1.3 V vs. Li⁺/Li and a reduction peak appeared in the vicinity of 0.4 V vs. Li⁺/Li. In addition, the reduction current as mentioned above is extremely similar to a reduction current deriving from reduction of the carbonate ions, which appears in the molten salt to which the carbonate ions are previously added, as shown in FIG. 16 (B). This result shows that the carbonate ions are generated in the molten salt which includes the oxide ions and into which the carbon dioxide is injected.

Next, as a result of performing the discharge electrolysis, the muddy carbon was formed in the electrolytic bath after the electrolysis. The muddy carbon was moved outside the electrolytic cell and was made to the solidified salt at a room temperature. The solidified salt including the muddy carbon was dissolved in warm water whose temperature was 50° C. or less or water, and while ultrasonic was applied thereto, carbon particles were suspended in the aqueous solution. The obtained aqueous solution was filtered by a membrane filter and carbon particles deposited on the filter were dried.

An interplanar spacing d (002) (nm) of the collected carbon particles in Example 8, a crystallite size (Lc (002) (nm) and La (110) (nm)) thereof, a mean secondary particle diameter (d50) (nm) thereof, and a specific surface area thereof were measured. A result in Example 8 is shown in Table 7. Note that a measurement method of these is similar to that in Examples 1 to 7.

TABLE 7

| | | | | | Specific |
|---|---|---|---|---|---|
| | | | | | surface |
| Carbon particles | d (002) | Lc (002) | La (110) | (d50) | area |
| (before heat treatment) | [nm] | [nm] | [nm] | [nm] | [m²/g] |
| Example 8 | 0.3362 | 1.4 | 1.7 | 193.2 | 523 |

As shown in Table 7, the interplanar spacing (d (002)) of the carbon particles in Example 8 was 0.3362 nm, and as in Examples 1 to 7, particles having crystallinity equivalent to that of the graphite were included.

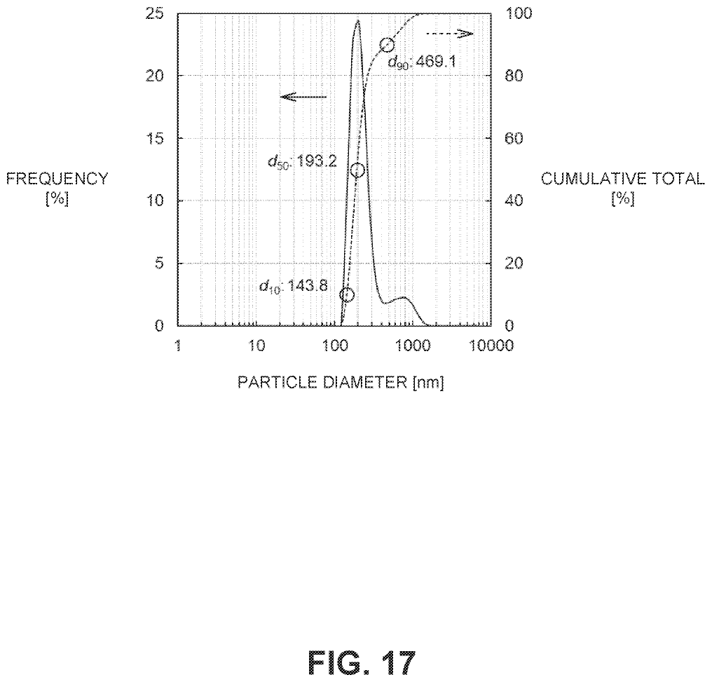

As shown in FIG. 17, the secondary particle diameter (d50) of the carbon particles obtained after cleaning and drying was 193.2 nm and was equivalent to that in each of Examples 1 to 7.

The BET specific surface area of the carbon particles was 523 m²/g and was equivalent to that in each of Examples 1 to 7.

### <Impurities in Carbon Particles>

As impurities of the carbon particles in Example 8, contained amounts of potassium and chlorine of molten salt components were measured. Note that a measurement method of these is similar to that in each of Examples 1 to 7. A result is shown in Table 8.

TABLE 8

| | Example 8 |
|---|---|
| Element | Contained amount [at%] |
| C | 99.05 |
| Cl | 0.52 |
| K | 0.43 |

### <Shapes of Carbon Particles>

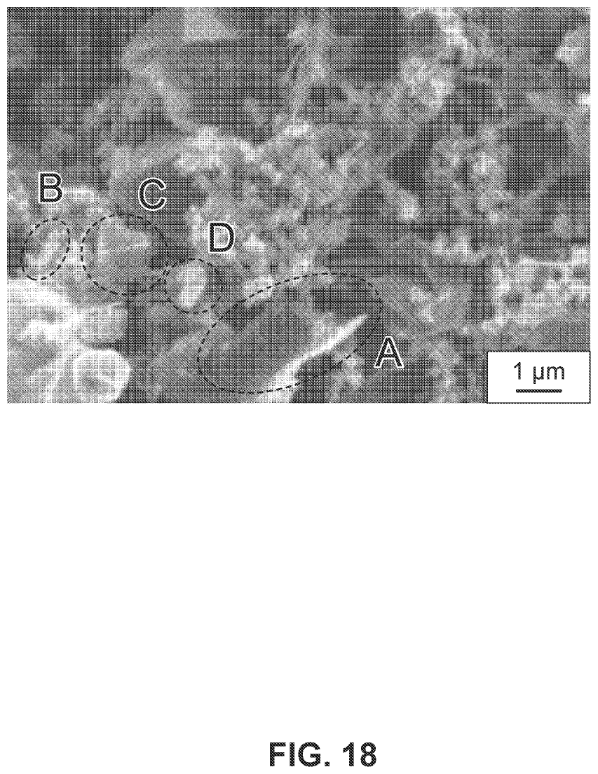

The carbon particles in Example 8 were observed by a SEM. As shown in FIG. 18, as in Examples 1 to 7, as to shapes of the carbon particles, particles each having a structure of not only a spherical shape but also a sheet shape, a ribbon shape, and a cube shape were also present, and particles having various shapes were included. In FIG. 18, in a portion surrounded by an A line, carbon particles each having the sheet shape were observed; in a portion surrounded by a B line, carbon particles each having the ribbon shape were observed; in a portion surrounded by a C line, carbon particles each having the cube shape were observed; and in a portion surrounded a D line, carbon particles each having the spherical shape were observed.

### <Manufacturing of Graphite Particles>

The carbon particles in Example 8 were subjected to heat treatment at 2800° C. for one hour, thereby obtaining graphite particles. An interplanar spacing d (002) (nm), a crystallite size (Lc (002) (nm), and La (110) (nm)), a mean secondary particle diameter (d50) (nm), and a specific surface area of the obtained graphite particles were measured in a manner similar to the manner in which the measurement for the carbon particles before the heat treatment was conducted. A result thereof is shown in Table 9.

TABLE 9

| Graphite particles | d (002) | Lc (002) | La (110) | (d50) | Specific surface |
|---|---|---|---|---|---|
| (after heat treatment) | [nm] | [nm] | [nm] | [nm] | area [m²/g] |
| Example 8 | 0.3369 | 12.2 | 58.7 | 168.4 | 68.6 |

As shown in Table 9, the interplanar spacing d (002) based on a diffraction peak corresponding to the lattice plane (002) of the graphite particles in Example 8 was 0.3369 nm.

### <Evaluation of Crystallinity of Graphite Particles>

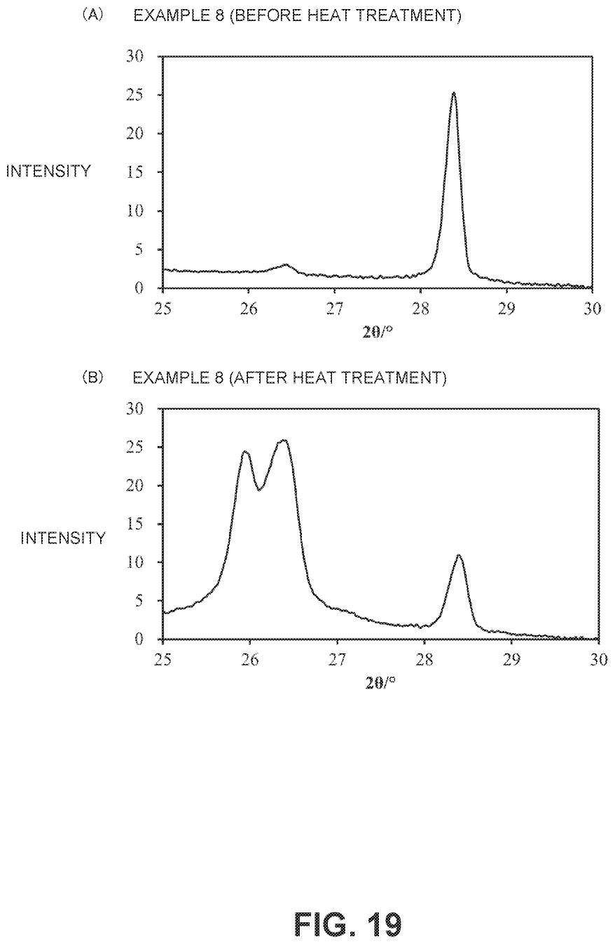

Crystallinity of the graphite particles generated by the above-mentioned manufacturing method was evaluated in a manner similar to the manner in which the crystallinity of the graphite particles in each of Examples 1 to 7 was evaluated. As shown in FIG. 19, a peak of the carbon particles before the heat treatment as the raw material of the graphite particles in the vicinity of 26.5° was very small and graphitic nature was substantially not observed, and after the heat treatment, a peak at a diffraction angle (2θ) 26.5° which was higher than a peak at a diffraction angle (2θ) 26° appeared, and it was made clear that as in Examples 1 to 7, a graphitic organizational structure in the particles was present.

A graphitization degree P1 representing a degree of progress of graphitizing was obtained and a result is shown in Table 10. It is indicated by P1 that the more proximate to one P1 is, the more progressing the graphitizing is, and it turned out that the high graphitization degree was represented though the graphitization degree did not reach that in each of Examples 1 to 7.

TABLE 10

| Example | d (002) [nm] | P1 |
|---|---|---|
| Example 8 | 0.3369 | 0.79 |

In addition, an interplanar spacing d (002) based on a diffraction peak corresponding to d (002) of the graphite particles in Example 8 was 0.3369 nm and was a value equivalent to that of each of the synthetic graphite and the natural graphite.

### <Crystallite Size of Graphite Particles>

As shown in Table 9, Lc (002) of the graphite particles after graphitizing was 12.2 nm and La (110) thereof was 58.7 nm.

As general synthetic graphite, Lc (002) of synthetic graphite manufactured by SEC CARBON, Ltd. is 117 nm, La (110) thereof is 284.6 nm. Both of Lc (002) and La (110) of the graphite particles in Example 8 as a crystallite size are ¼ or less of those of the general synthetic graphite.

### <Particle Diameter of Graphite Particles>

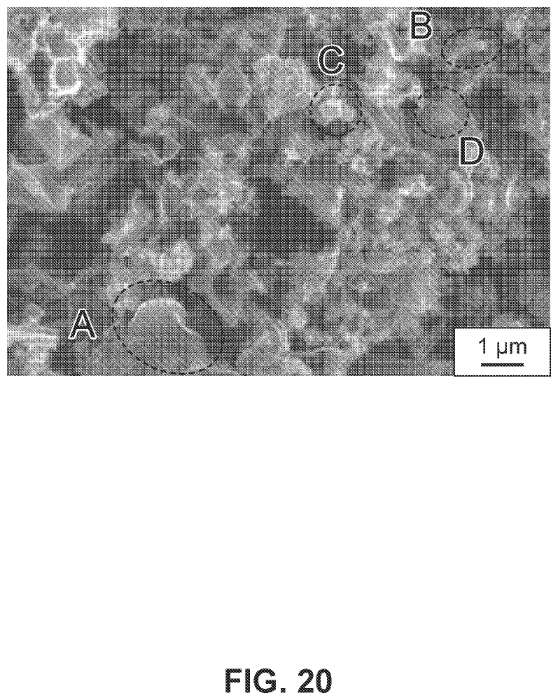

As shown in Table 9, a secondary particle diameter of the graphite particles was 0.1684 μm, and a particle diameter after graphitizing was substantially the same as the particle diameter of the carbon particles as the raw material. As shown in FIG. 20, as a result of the SEM observation, it was confirmed that aggregation of the carbon particles due to the heat treatment did not occur.

It is considered that it was made possible to obtain further minute graphite particles without the occurrence of the aggregation due to the heat treatment because the crystal structure of the carbon particles before the heat treatment had already approached to that of the graphite since the peak higher than the peak shown in FIG. 19 (A) appeared at the diffraction angle (2θ) 26.5°.

A primary particle diameter of the graphite particles in Example 8, which was visually measured by a SEM (electron microscope), as shown in FIG. 20, was a particle diameter of 50 nm or more and 500 nm or less, as in Examples 1 to 7.

### <Specific Surface Area>

As to the graphite particles in Example 8, a specific surface area (BET) calculated from the nitrogen-adsorption amount at 77 K was 68.6 m²/g.

### <Shapes of Graphite Particles>

A graphite pulverulent body in Example 8 was observed by a SEM. As a result, as in Examples 1 to 7, as to shapes of the graphite particles, particles each having a structure of not only a spherical shape but also a sheet shape, a cube shape, and a ribbon shape were present, and the graphite particles had various shapes. In FIG. 20, in a portion surrounded by an A line, graphite particles each having the sheet shape were observed; in a portion surrounded by a B line, graphite particles each having the ribbon shape were observed; in a portion surrounded by a C line, graphite particles each having the cube shape were observed; and in a portion surrounded by a D line, graphite particles each having the spherical shape were observed. As these results obtained by the SEM observation, it was found that also in the graphite particles obtained by subjecting the carbon particles generated by the electrolysis with the carbon dioxide as the raw material of the carbonate ions, not only the spherical shape particles but also the sheet shape particles, the ribbon shape particles, and the cube shape particles were present in a mixed manner and particles having various shapes were included.

### <Impurities in Graphite Particles>

As impurities of the carbon particles in Example 8, contained amounts of potassium and chlorine of molten salt components were measured. Note that a measurement method of these is similar to that in each of Examples 1 to 7. A result is shown in Table 11.

TABLE 11

| | Example 8 |
|---|---|
| Element | contained amount [at %] |
| C | 99.99 |
| Cl | 0.01 |
| K | 0.00 |

As shown in Table 11, it was confirmed that by performing the heat treatment at 2800° C., the impurities substantially vanished.

The invention of the present application is summarized as follows.
[1] The interplanar spacing d 002 of the graphite particles, manufactured by the manufacturing method according to the present invention, based on the diffraction peak corresponding to the lattice plane (002), which is measured by the powder X-ray diffraction method, is 0.3355 nm or more and 0.3370 nm or less; the primary particle diameter of the graphite particles is 50 nm or more and 500 nm or less; the integrated value in the number base particle diameter distribution of the graphite particles which is a value (a mean particle diameter) of 50% is defined as the secondary particle diameter (d50), and the secondary particle diameter (d50) is 0.15 μm or more and 1.6 μm or less; and the specific surface area (BET) of the graphite particles, which is calculated from the nitrogen-adsorption amount at 77 K is 10 m²/g or more and 400 m²/g or less.
[2] It is preferable that the graphite particles in the above-described [1] include the spherical shape particles, the sheet shape particles, the ribbon shape particles, and the cube shape particles.
[3] It is preferable that the graphite particles in the above-described [1] or [2] are graphite particles obtained by subjecting the carbon particles, obtained by electrolyzing the carbon dioxide, to the heat treatment.
[4] It is preferable that as to the graphite particles in the above-described [3], a 30 secondary particle diameter (d50) of the carbon particles is 100 nm or more and 200 nm or less and the carbon particles include crystals whose interplanar spacing d 002 is 0.3360 nm or more and 0.3373 nm or less, and the specific surface area of the carbon particles is 200 m²/g or more and 600 m²/g or less.
[5] It is preferable that as to the graphite particles in the above-described [3] or [4], the carbon particles include the spherical shape particles, the sheet shape particles, the ribbon shape particles, and the cube shape particles.
[6] The method for manufacturing graphite particles according to the present invention includes; (a) a step of preparing an electrolytic bath which includes molten salt containing carbonate ions; (b) a step of locating a cathode in the vicinity of a surface of the electrolytic bath outside the electrolytic bath; (c) a step of locating an anode in the electrolytic bath; (d) a step of reducing the carbonate ions by generating electric discharge between the cathode and the surface of the electrolytic bath and performing energization by applying a voltage for generating carbon particles between the anode and the cathode; (e) a step of collecting the carbon particles together with the molten salt and removing cooled and solidified salt by water washing; and (f) a step of graphitizing the carbon particles obtained in the (e) step by heat treatment.
[7] In the above-described [6] manufacturing method, it is preferable that (a) the step of preparing the electrolytic bath which includes the molten salt containing the carbonate ions is performed by injecting carbon dioxide gas into the electrolytic bath which includes the molten salt containing the oxide ions.
[8] In the above-described [6] or [7] manufacturing method, it is preferable that a temperature immediately beneath the cathode in the vicinity of the surface of the electrolytic bath is approximately 3000° C.
[9] In the manufacturing method of any of the above-described [6] to [8], it is preferable that the carbon particles include the crystals whose secondary particle diameter (d50) is 100 nm or more and 200 nm or less and interplanar spacing d 002 is 0.3360 nm or more and 0.3373 nm or less, and the specific surface area is 200 m²/g or more and 600 m²/g or less.
[10] In the manufacturing method of any of the above-described [6] to [9], it is preferable that the carbon particles include the spherical shape particles, the sheet shape particles, the ribbon shape particles, and the cube shape particles.
[11] In the manufacturing method of any of the above-described [6] to [10], it is preferable that the heat treatment is performed at a temperature of 2800° C. or more.

The described embodiment and examples are to be considered in all respects only as illustrative and not restrictive. It is intended that the scope of the invention is, therefore, indicated by the appended claims rather than the foregoing description of the embodiment and examples and that all modifications coming within the meaning and equivalency range of the appended claims are embraced within their scope.

1. A method for manufacturing graphite particles comprising:
(a) a step of preparing an electrolytic bath which includes molten salt containing carbonate ions;
(b) a step of locating a cathode in a vicinity of a surface of the electrolytic bath outside the electrolytic bath;
(c) a step of locating an anode in the electrolytic bath;
(d) a step of reducing the carbonate ions by generating electric discharge between the cathode and the surface of the electrolytic bath and performing energization by applying a voltage for generating carbon particles between the anode and the cathode;
(e) a step of collecting the carbon particles together with the molten salt and removing cooled and solidified salt by water washing; and
(f) a step of graphitizing the carbon particles being obtained in (e) the step by heat treatment.

2. The method for manufacturing graphite particles according to claim 1, wherein (a) the step of preparing the electrolytic bath which includes the molten salt containing the carbonate ions is performed by injecting carbon dioxide gas into the electrolytic bath which includes the molten salt containing the oxide ions.

3. The method for manufacturing graphite particles according to claim 1, wherein, a temperature immediately beneath a cathode in a vicinity of a surface of the electrolytic bath is approximately 3000° C.

4. The method for manufacturing graphite particles according to claim 1, wherein a secondary particle diameter (d50) of the carbon particles is 100 nm or more and 200 nm or less,
the carbon particles include crystals whose interplanar spacing d 002 is 0.3360 nm or more and 0.3373 nm or less, and
a specific surface area of the carbon particles is 200 m²/g or more and 600 m²/g or less.

5. The method for manufacturing graphite particles according to claim 1, wherein the carbon particles include spherical shape particles, sheet shape particles, ribbon shape particles, and cube shape particles.
